(19) United States
(12) Patent Application Publication
(10) Pub. No.: US 2025/0224833 A1
(43) Pub. Date: Jul. 10, 2025

(54) TOUCH DETECTION MODULE AND DISPLAY DEVICE INCLUDING THE SAME

(71) Applicant: Samsung Display Co., Ltd., Yongin-Si (KR)

(72) Inventors: Jin Woo PARK, Yongin-si (KR); Jeon Min KANG, Yongin-si (KR); Il Ho LEE, Yongin-si (KR)

(21) Appl. No.: 18/896,590

(22) Filed: Sep. 25, 2024

(30) Foreign Application Priority Data
Jan. 8, 2024 (KR) 10-2024-0002708

(51) Int. Cl. G06F 3/041

(52) U.S. Cl. CPC G06F 3/04166; G06F 3/0418

(57) ABSTRACT

A touch detection module includes a touch sensing unit and a touch driving circuit. The touch sensing unit includes touch electrodes and an inspection signal transmission line. The touch electrodes in a touch sensing area of the touch sensing unit connect to touch lines extending through a touch peripheral area of the touch sensing unit. The touch driving circuit supplies an inspection signal to the inspection signal transmission line and touch driving signals to the touch electrodes. The supplied touch driving signals depends on a voltage magnitude or a current amount of the inspection signal, wherein the touch driving circuit supplies the touch driving signals to the touch electrodes and detects touch sensing signals from the touch electrodes to detect coordinates of a touch location.

### CROSS-REFERENCE TO RELATED APPLICATION

This application claims priority from Korean Patent Application No. 10-2024-0002708 filed on Jan. 8, 2024 in the Korean Intellectual Property Office, and all the benefits accruing therefrom under 35 U.S.C. 119, the contents of which in its entirety are herein incorporated by reference.

### BACKGROUND

### Technical Field

The present disclosure relates to a touch detection module and a display device including the same.

### Description of the Related Art

The advance of our information-oriented society has placed more and more demands on display devices that display images for various purposes and in various ways. For example, display devices have been applied to various electronic devices, such as smart phones, digital cameras, laptop computers, navigation systems, and smart televisions.

A display device may be a flat panel display device such as a liquid crystal display device, a field emission display device, or an organic light emitting display device. Among the flat panel display devices, each of the pixels in a display panel of a light emitting display device generally includes a light emitting element capable of emitting light, allowing an image to be displayed without a backlight unit providing light to the display panel.

A modern display device may include a touch detection module for sensing a user's touch as an input interface. The touch detection module may include a touch sensing unit, which includes touch electrodes, and a touch driving circuit, which is capable of detecting an amount of charge in capacitance between the touch electrodes. The touch detection module may be integrally formed on an image display unit of the display device or may be separately fabricated and then mounted on a front surface of the image display unit.

### SUMMARY

Aspects of the present disclosure may provide a touch detection module capable of detecting manufacturing process deviations and electrical signal transmission deviations for each touch sensor and display panel in real time and may provide a display device including the same.

Aspects of the present disclosure may also provide a touch detection module capable of changing and applying a voltage magnitude and a current amount of a touch driving signal supplied to touch electrodes in real time in response to manufacturing process deviations and electrical signal transmission deviations and may provide a display device including the same.

Aspects of the present disclosure are not restricted to those set forth herein. The above and other aspects of the present disclosure will become more apparent to one of ordinary skill in the art to which the present disclosure pertains by referencing the detailed description of the present disclosure given below.

According to an embodiment of the disclosure, a touch detection module comprising a touch sensing unit and an inspection signal transmission line. The touch electrodes are in a touch sensing area and connect to touch lines that extend through a touch peripheral area. A touch driving circuit supplies an inspection signal to the inspection signal transmission line and changes a voltage magnitude or current amount of touch driving signals according to a voltage magnitude or a current amount of the inspection signal, wherein the touch driving circuit supplies the touch driving signals in which the voltage magnitude or the current amount has changed to the touch electrodes and detects touch sensing signals from the touch electrodes to detect coordinates of a touch location.

According to an embodiment of the disclosure, a display device comprises a display panel including a display area in which a plurality of subpixels are arranged, and a touch detection module on the display panel and configured to sense touch of a user. The touch detection module comprises a touch sensing unit including touch electrodes and an inspection signal transmission line. The touch electrodes are in a touch sensing area of the touch sensing unit and are connected to touch lines that extend through a touch peripheral are of the touch sensing unit. A touch driving circuit supplies an inspection signal to the inspection signal transmission line and changes a current amount or voltage magnitude of the touch driving signals according to a change in the current amount or the voltage magnitude of the inspection signal. The touch driving circuit supplies the touch driving signals in which the voltage magnitude or the current amount has changed to the touch electrodes and detects touch sensing signals from the touch electrodes to detect coordinates of a touch location.

The touch detection module and the display device including the same according to the embodiments of the present disclosure may improve touch sensing performance by varying the supply characteristics of touch driving signals according to manufacturing process deviations and signal transmission deviations for each touch sensing unit and display panel.

In addition, defect rates may be reduced and manufacturing yield may be improved by changing and applying the voltage magnitude and the current amount of a touch driving signal in response to manufacturing process deviations and electrical signal transmission deviations for each touch sensing unit and display panel in real time.

The effects of the embodiments are not restricted to those set forth herein. The above and other effects of the embodiments will become more apparent to one of daily skill in the art to which the embodiments pertain by referencing the claims.

### BRIEF DESCRIPTION OF THE DRAWINGS

FIG. 1 is a perspective view illustrating a display device according to one embodiment of the present disclosure.

FIG. 2 is a plan view illustrating a display device according to one embodiment of the present disclosure.

FIG. 3 is a side view illustrating a display device according to one embodiment of the present disclosure.

FIG. 4 is a layout view illustrating an example of a layout of the display panel shown in FIGS. 1 to 3.

FIG. 5 is a layout view schematically illustrating a first embodiment of a touch sensing unit shown in FIG. 3.

FIG. 6 is a layout view schematically illustrating a second embodiment of a touch sensing unit shown in FIG. 3.

FIG. 7 is a layout view schematically illustrating a third embodiment of a touch sensing unit shown in FIG. 3.

FIG. 8 is a layout view schematically illustrating a fourth embodiment of a touch sensing unit shown in FIG. 3.

FIG. 9 is a block diagram schematically illustrating a first embodiment for a configuration of a touch driving circuit shown in FIGS. 1 to 3.

FIG. 10 is a block diagram schematically illustrating a second embodiment for a configuration of a touch driving circuit shown in FIGS. 1 to 3;

FIGS. 11 and 12 are perspective views illustrating a display device according to another embodiment of the present disclosure.

FIGS. 13 and 14 are perspective views illustrating a display device according to still another embodiment of the present disclosure.

### DETAILED DESCRIPTION OF THE EMBODIMENTS

Some embodiments of the present disclosure are described more fully hereinafter with reference to the accompanying drawings. This disclosure may, however, be embodied in different forms and should not be construed as limited to the embodiments set forth herein. Rather, these embodiments are provided so that this disclosure will be thorough and complete and will fully convey the scope of the disclosure to those skilled in the art.

In the following, a layer referred to as being “on” another layer or substrate may be directly on the other layer or substrate, or intervening layers may also be present.

The terms “first,” “second,” etc. may be used herein to describe various elements, but these elements are not limited by these terms. The terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined with each other, in part or in whole, and various interlocking and driving of features are possible. Each embodiment may be implemented independently of other embodiments, or multiple embodiments may be implemented together in an association.

Specific embodiments are described hereinafter with reference to the accompanying drawings. The same reference numbers used in the various drawings and throughout this specification indicate the same or corresponding components.

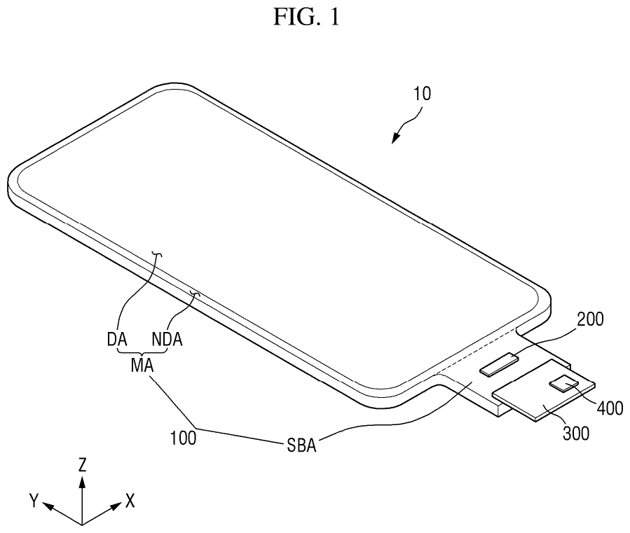

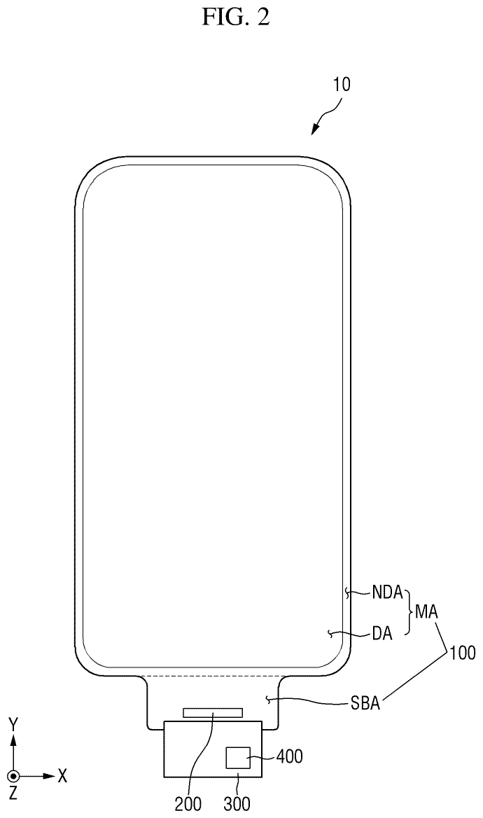

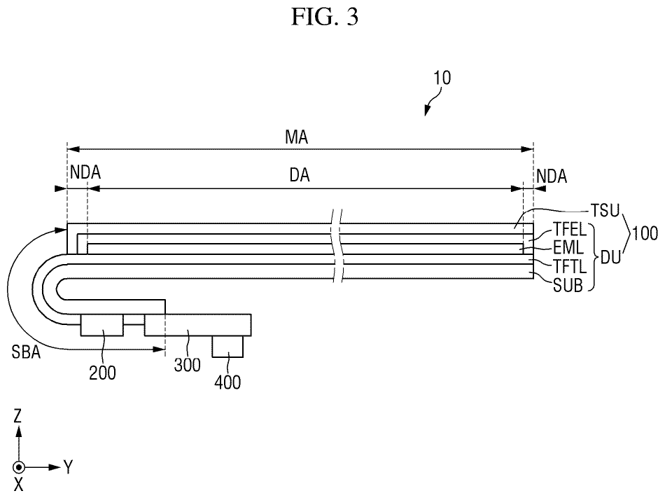

FIG. 1 is a perspective view illustrating a display device according to one embodiment of the present disclosure. FIG. 2 is a plan view illustrating an unbent state of the display device of FIG. 1, and FIG. 3 is a side view illustrating the display device of FIG. 1 in a bent state.

Referring to FIGS. 1 to 3, a display device 10 according to one embodiment may be applied to portable electronic devices such as a mobile phone, a smartphone, a tablet personal computer, a mobile communication terminal, an electronic organizer, an electronic book, a portable multimedia player (PMP), a navigation system, an ultra mobile PC (UMPC) or the like. In addition, the display device 10 may be applied as a display unit of a television, a laptop, a monitor, a billboard, or an Internet-of-Things (IoT) terminal. Further, the display device 10 may be applied to wearable devices such as a smart watch, a watch phone, a glasses type display, or a head mounted display (HMD). Alternatively, the display device 10 may be applied to a dashboard of a vehicle, a center fascia of a vehicle, a center information display (CID) disposed on a dashboard of a vehicle, a room mirror display in place of side mirrors of a vehicle, or a display disposed on a rear surface of a front seat for rear seat entertainment of a vehicle.

The display device 10 according to one embodiment may be a light emitting display device such as an organic light emitting display device using organic light emitting diodes, a quantum dot light emitting display including a quantum dot light emitting layer, an inorganic light emitting display including an inorganic semiconductor in light emitting diodes, or a micro light emitting display using micro or nano light emitting diodes. The following description focuses on an embodiment in which the display device 10 is an organic light emitting display device, but the present disclosure is not limited thereto.

The display device 10 according to one embodiment includes a display panel 100 that includes a display module DU, a display driving circuit 200, a display circuit board 300, a touch sensing unit TSU and a touch driving circuit 400.

The display panel 100 may have a rectangular shape, in plan view with short sides extending in a first direction (X-axis direction) and long sides extending in a second direction (Y-axis direction) crossing the first direction (X-axis direction). Each corner where a short side and a long side meet may be rounded to have a predetermined curvature or may be right-angled. The planar shape of the display panel 100 is not limited to the rectangular shape, and the display panel 100 may be formed in another polygonal shape, a circular shape, an elliptical shape, or any other desired shape. The display panel 100 may be flat but is not limited thereto. For example, the display panel 100 may include a curved portion formed at left and right ends and having a constant curvature or a varying curvature. In addition, the display panel 100 may be flexible so that the display panel 100 can be bent, folded, or rolled.

The display panel 100 includes a main area MA and a sub-area SBA.

The main area MA includes a display area DA for displaying an image and a non-display area NDA that is a peripheral area of the display area DA. The display area DA includes pixels for displaying an image. The sub-area SBA may protrude in the second direction (Y-axis direction) from one side of the main area MA.

FIGS. 1 and 2 show the sub-area SBA unfolded, but the sub-area SBA may be bent as illustrated in FIG. 3, and in this case, at least a portion of the sub-area SBA may be disposed on a lower surface of the display panel 100. When the sub-area SBA is bent, the sub-area SBA may overlap the main area MA in a third direction (Z-axis direction) which is a thickness direction of a substrate SUB. The display driving circuit 200 may be disposed in the sub-area SBA.

The display panel 100 includes the display module DU and the touch sensing unit TSU. As shown in FIG. 3, the display module DU may include a substrate SUB, a thin film transistor layer TFTL, a light emitting element layer EML, and an encapsulation layer TFEL, and the touch sensing unit TSU may be formed on a front surface of the display module DU.

The thin film transistor layer TFTL may be disposed on the substrate SUB. The thin film transistor layer TFTL may be disposed in the main area MA and the sub-area SBA. The thin film transistor layer TFTL includes thin film transistors.

A light emitting element layer EML may be disposed on the thin film transistor layer TFTL. The light emitting element layer EML may be disposed in the display area DA of the main area MA. The light emitting element layer EML includes light emitting elements disposed in light emitting portions of the display module DU.

The encapsulation layer TFEL may be disposed on the light emitting element layer EML. The encapsulation layer TFEL may be disposed in the display area DA and the non-display area NDA of the main area MA. The encapsulation layer TFEL may include at least one inorganic layer and at least one organic layer for encapsulating the light emitting element layer.

The touch sensing unit TSU may be formed integrally with the encapsulation layer TFEL on the front surface of the encapsulation layer TFEL or may be fabricated separately and then mounted on the front surface of the encapsulation layer TFEL. The touch sensing unit TSU may particularly be disposed on the display area DA of the main area MA. The touch sensing unit TSU may use touch electrodes to detect the touch of an electronic pen and or human body parts such as fingers. Specifically, the touch sensing unit TSU may use touch electrodes and a capacitance detection method or a voltage magnitude change detection method to detect a touch and identify a touch position.

At least one inspection signal transmission line used to detect manufacturing process deviations during fabrication of the display panel 100 and the touch sensing unit TSU may be formed in the touch sensing unit TSU. At least one inspection signal transmission line may be formed through the same process on the same process layer with the same metal material as at least one touch electrode or at least one touch line. At least one inspection signal transmission line may be formed in an area corresponding to the non-display area NDA or the sub-area SBA. In addition, at least one inspection signal transmission line may be formed to cross both the display area DA and the non-display area NDA.

A cover window that protects an upper portion of the display panel 100 may be disposed on the touch sensing unit TSU. The cover window may be attached onto the touch sensing unit TSU by a transparent adhesive member such as an optically clear adhesive (OCA) layer or an optically clear resin (OCR) layer. The cover window may also be made of an inorganic material such as glass or an organic material such as plastic or a polymer material. A polarizing layer may be added between the touch sensing unit TSU and the cover window to prevent deterioration of image visibility due to reflection of external light.

The display driving circuit 200 may generate signals and voltages for driving the display panel 100. The display driving circuit 200 may be an integrated circuit (IC) that is attached onto the display panel 100 in a chip on glass (COG) manner, a chip on plastic (COP) manner, or an ultrasonic bonding manner, but embodiments in accordance with this disclosure are not limited thereto. For example, the display driving circuit 200 may be attached onto the circuit board 300 in a chip on film (COF) method.

The circuit board 300 may be attached to one end of the sub-area SBA of the display panel 100 and may be electrically connected to the display panel 100 and the display driving circuit 200. The display panel 100 and the display driving circuit 200 may receive digital video data, timing signals, and driving voltages through the circuit board 300. The circuit board 300 may be a flexible film such as a flexible printed circuit board, a printed circuit board, or a chip on film.

The touch driving circuit 400 may be disposed on the circuit board 300. The touch driving circuit 400 may be an integrated circuit (IC) that is attached to the circuit board 300.

The touch driving circuit 400 is electrically connected to the touch electrodes of the touch sensing unit TSU. In addition, the touch driving circuit 400 is electrically connected to at least one inspection signal transmission line formed in the touch sensing unit TSU for detecting manufacturing process deviations in the display panel 100 and the touch sensing unit TSU.

The touch driving circuit 400 supplies an electrical inspection signal to an inspection signal transmission line formed in the touch sensing unit TSU to detect manufacturing process deviations in the display panel 100 and the touch sensing unit TSU. The touch driving circuit 400 may supply the inspection signal to the inspection signal transmission line in real time or for each preset period. Then, changes in the voltage magnitude or current amount of the inspection signal may be detected in real time or for each preset period. Changes in the voltage magnitude or current amount of the inspection signal may be detected differently depending on the manufacturing process deviations for each of the display panel 100 and the touch sensing unit TSU. Changes in the voltage magnitude or current amount of the inspection signal may be detected differently depending on usage conditions such as the usage environment and usage time of the display panel 100 and the touch sensing unit TSU. The touch driving circuit 400 may change the voltage magnitudes or current amounts of the touch driving signals supplied to the touch electrodes to correspond to changes in the voltage magnitude or current amount of the inspection signal.

The touch driving circuit 400 may apply touch driving signals in which the voltage magnitude or current amount to the touch electrodes of the touch sensing unit TSU is changed, and a touch may be sensed by measuring charge change amount of mutual capacitance of each of the plurality of touch nodes formed by the touch electrodes. Specifically, the touch driving circuit 400 supplies touch driving signals to the touch electrodes in the touch sensing unit TSU and measures the change in capacitance between touch nodes according to changes in the voltage magnitude or current amount of touch sensing signals received through the touch electrodes. In this way, the touch driving circuit 400 may determine whether or not a user's touch is made, whether or not a user's approach is made, and the like, according to the amount of charge change in the mutual capacitance of each of the touch nodes.

Alternatively, the touch driving circuit 400 may supply touch driving signals simultaneously or sequentially to touch electrodes in the touch sensing unit TSU and may detect changes of the voltage magnitude or current amount of the touch sensing signals received through the touch electrodes. In this way, the touch driving circuit 400 may detect whether the user has touched the device and may calculate the coordinates of a touch location by detecting changes in the voltage magnitude or current amount of each touch electrode.

The user's touch indicates that a user's finger or an object such as a pen comes into direct contact with one surface of the cover window disposed on the touch sensing unit TSU. The user's approach indicates that the user's finger or an object such as the pen hovers above one surface of the cover window.

The display driving circuit 200 may operate as a main processor or may be formed integrally with the main processor. Accordingly, the display driving circuit 200 may control the overall function of the display device 10. For example, the display driving circuit 200 may receive touch data from the touch driving circuit 400, determine user's touch coordinates, and then generate digital video data according to the touch coordinates. In addition, the display driving circuit 200 may execute an application indicated by an icon displayed at the user's touch coordinates. As still another example, the display driving circuit 200 may receive coordinate data from an electronic pen or the like, determine touch coordinates of the electronic pen, and then generate digital video data according to the touch coordinates, or also execute an application indicated by an icon displayed on the touch coordinates of the electronic pen.

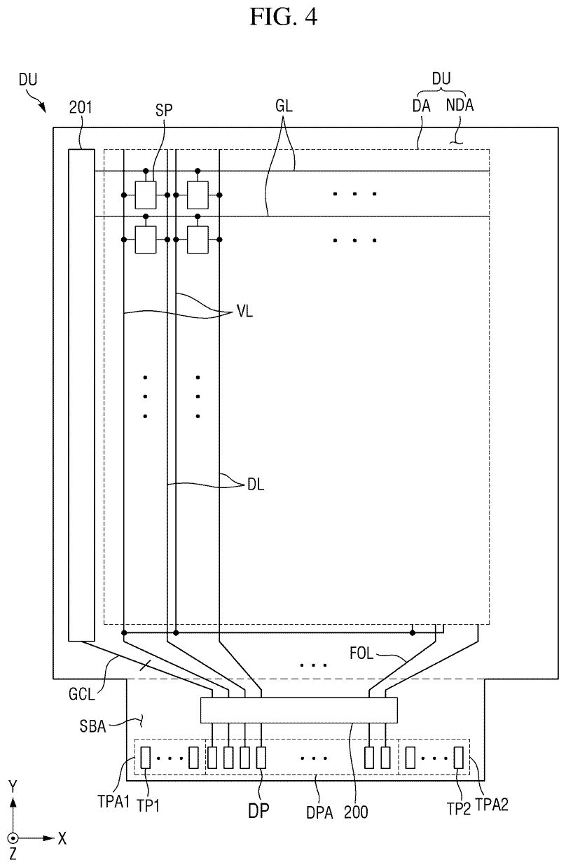

FIG. 4 shows an example of a layout of the display panel shown in FIGS. 1 to 3. Specifically, FIG. 4 is a layout view illustrating a display area DA and a non-display area NDA of the display module DU before the touch sensing unit TSU is formed.

The display area DA, which is an area displaying an image, may be a central area of the display panel 100. The display area DA may include a plurality of pixels SP, a plurality of gate lines GL, a plurality of data lines DL, and a plurality of voltage lines VL. Each of the plurality of pixels SP may be defined as a minimum unit for outputting light.

The plurality of gate lines GL may supply to the plurality of pixels SP the gate signals received from a gate driver 201. The plurality of gate lines GL may extend in the x-axis direction and may be spaced apart from one another in the y-axis direction, which crosses the x-axis direction.

The plurality of data lines DL may provide to the plurality of pixels SP the data voltages received from the display driving circuit 200. The plurality of data lines DL may extend in the y-axis direction and may be spaced apart from one another in the x-axis direction.

The plurality of voltage lines VL may supply the supply to the plurality of pixels SP voltages received from the display driving circuit 200. The supply voltage may be at least one of a driving voltage, an initialization voltage, and a reference voltage. The plurality of voltage lines VL may be extended in the y-axis direction and may be spaced apart from one another in the x-axis direction.

The non-display area NDA may surround the display area DA. The non-display area NDA may include the gate driver 201, fan-out lines FOL, and gate control lines GCL. The gate driver 201 may generate a plurality of gate signals based on the gate control signal and may sequentially supply the plurality of gate signals to the plurality of gate lines GL in a predetermined order.

The fan-out lines FOL may extend from the display driving circuit 200 to the display area DA. The fan-out lines FOL may supply to the plurality of data lines DL the data voltages received from the display driving circuit 200.

The gate control lines GCL may extend from the display driving circuit 200 to the gate driver 201. The gate control lines GCL may supply to the gate driver 201 the gate control signal received from the display driving circuit 200.

The sub-area SBA may include the display driving circuit 200, a display pad area DPA, and first and second touch pad areas TPA1 and TPA2.

The display driving circuit 200 may output signals and voltages for driving the display panel 100 to the fan-out lines FOL. The display driving circuit 200 may provide data voltages to the data lines DL through the fan-out lines FOL. The data voltages may be applied to the plurality of pixels SP and may control the luminance of the plurality of pixels SP. The display driving circuit 200 may supply a gate control signal to the gate driver 201 through the gate control lines GCL.

The display pad area DPA, the first touch pad area TPA1, and the second touch pad area TPA2 may be disposed on or near the edge of the sub-area SBA. The display pad area DPA, the first touch pad area TPA1, and the second touch pad area TPA2 may be electrically connected to the circuit board 300 using a low-resistance, high-reliability material such as an anisotropic conductive layer and an SAP.

The display pad area DPA may include a plurality of display pads. The plurality of display pads may be connected to the display driving circuit 200 or the touch driving circuit 400 through the circuit board 300. The plurality of display pads may be connected to the circuit board 300 to receive digital video data and may provide digital video data to the display driving circuit 200.

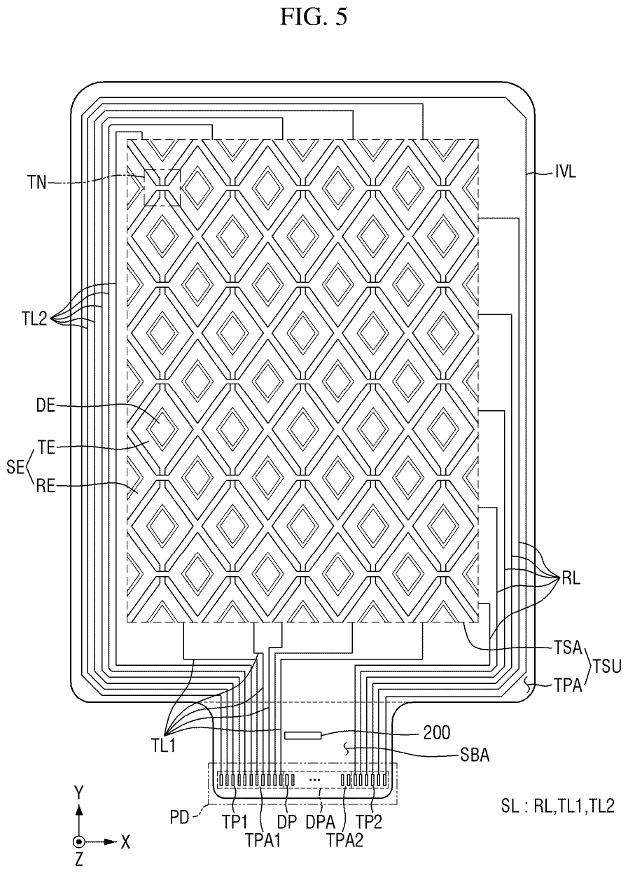

FIG. 5 is a layout view schematically illustrating a first embodiment of a touch sensing unit shown in FIG. 3.

Referring to FIG. 5, touch electrodes SE of the main area MA are divided into two kinds of electrodes, e.g., the driving electrodes TE and the sensing electrodes RE. The mutual capacitive sensing may be carried out by applying touch driving signals to the driving electrode TE, and then sensing the amount of change in the mutual capacitance of each of the touch nodes TN through the sensing electrodes RE. It should be noted that the type and arrangement structure of the touch electrodes SE and the method of driving the touch electrodes SE are not limited to the capacitive sensing.

For convenience of illustration, FIG. 5 shows only the driving electrodes TE, the sensing electrodes RE, dummy patterns DE, touch lines SL, at least one inspection signal transmission line IVL, and first and second touch pads TP1 and TP2.

Referring to FIG. 5, the touch sensing unit TSU includes a touch sensing area TSA for sensing a user's touch and a touch peripheral area TPA disposed around a touch sensing area TSA. The touch sensing area TSA may overlap with the display area DA of FIGS. 1 to 3, and the touch peripheral area TPA may overlap with the non-display area NDA.

The driving electrodes TE, the sensing electrodes RE and the dummy patterns DE are disposed in the touch sensing area TSA. The driving electrodes TE and the sensing electrodes RE may be electrodes for forming mutual capacitance to sense a touch of an electronic pen or a person.

The driving electrodes TE may be arranged in the first direction (x-axis direction) and second direction (y-axis direction). The driving electrodes TE adjacent to each other in the first direction (x-axis direction) are electrically separated from to each other, while the driving electrodes TE adjacent to each other in the second direction (y-axis direction) are electrically connected to each other. The driving electrodes TE adjacent to one another in the second direction (y-axis direction) may be connected through separated connection electrodes.

The sensing electrodes RE may be arranged in the first direction (x-axis direction) and second direction (y-axis direction). The sensing electrodes RE adjacent to each other in the first direction (x-axis direction) may be electrically connected with each other. The sensing electrodes RE adjacent to each other in the second direction (y-axis direction) may be electrically separated from each other. Accordingly, the touch nodes TN where mutual capacitance is formed may be at intersections of the driving electrodes TE and the sensing electrodes RE. A plurality of touch nodes TN may be associated with the intersections of the driving electrodes TE and the sensing electrodes RE.

Each of the dummy patterns DE may be surrounded by an associated one of the driving electrodes TE or the sensing electrodes RE. Each of the dummy patterns DE may be electrically separated from the surrounding driving electrode TE or the surrounding sensing electrode RE. Each of the dummy patterns DE may be spaced apart from the surrounding driving electrode TE or the surrounding sensing electrode RE. Each of the dummy patterns DE may be electrically floating.

In FIG. 5, the driving electrodes TE, the sensing electrodes RE, and the dummy patterns DE each have a diamond shape when viewed from the top, but the present disclosure is not limited thereto. For example, each of the driving electrodes TE, the sensing electrodes RE and the dummy patterns DE may have a quadrangular shape other than a diamond, a polygonal shape other than a quadrangular shape, a circular shape or an elliptical shape when viewed from the top.

Touch lines SL and at least the one inspection signal transmission line IVL may be disposed around the touch sensing area TSA, that is, in the touch peripheral area TPA.

The touch lines SL include first touch driving lines TL1 and second touch driving lines TL2 connected to the driving electrodes TE, and touch sensing lines RL connected to the sensing electrodes RE.

The sensing electrodes RE disposed at one edge of the touch sensing area TSA may be connected to the touch sensing lines RL, respectively. For example, the sensing electrodes RE that are disposed at the right edge may be directly connected to the touch sensing lines RL, respectively, as shown in FIG. 5, and those sensing electrodes RE electrically connected with other sensing electrodes RE along the first direction (x-axis direction). Each of the touch sensing lines RL may extend through the touch peripheral area TPA to connect to a pad in a pad unit PD. For example, the touch sensing lines RL may extend around the right side of the touch sensing area TSA and may respectively connect to second touch pads TP2 disposed in the pad unit PD.

The driving electrodes TE disposed at one edge, e.g., the lower edge, of the touch sensing area TSA may be respectively connected to the first touch driving lines TL1, while the driving electrodes TE disposed at the opposite edge, e.g., the upper edge, of the touch sensing area TSA may be respectively connected to the second touch driving lines TL2. For example, some of the driving electrodes TE electrically connected to one another in the second direction (y-axis direction) including a driving electrode at the lower end of the touch sensing area TSA may be connected to the first touch driving lines TL1, respectively, while driving electrodes TE that connected in the second direction (y-axis direction) and include a driving electrode TE at the upper end may be connected to the second touch driving lines TL2, respectively.

The first and second touch driving lines TL1 and TL2 may be connected to the pad unit PD formed in the sub-area SBA of the display panel 100 via a portion of the touch peripheral area TPA. For example, the second touch driving lines TL2 may extend around the left side of the touch sensing area TSA and connect to the driving electrodes TE on the upper side of the touch sensing area TSA. The first and second touch driving lines TL1 and TL2 may also connect to the pad unit PD formed in the sub-area SBA adjacent to the lower side of the touch sensing area TSA. The first and second touch driving lines TL1 and TL2 may particularly connect to respective first touch pads TP1 in the pad unit PD.

The driving electrodes TE are connected to the first and second touch driving lines TL1 and TL2 on opposite sides of the touch sensing area TSA to receive touch driving signals through the first and second touch driving lines TL1 and TL2 on opposite sides. These connections may prevent a RC delay of the touch driving signals from causing a difference between the touch driving signals applied to the driving electrodes TE disposed on the lower side of touch sensing area TSA and the touch driving signals applied to the driving electrodes TE disposed on the upper side of the touch sensing area TSA.

At least the one inspection signal transmission line IVL may be disposed in the touch peripheral area TPA along the periphery of the touch sensing area TSA. The inspection signal transmission line IVL may be formed through the same process on the same process layer with the same metal material as at least any one electrode or line among at least one driving electrode TE, a sensing electrode RE, a dummy pattern DE, first and second touch driving lines TL1 and TL2, and a touch sensing line RL. The inspection signal transmission line IVL may be formed only in touch peripheral area TPA. For example, a path of the inspection signal transmission line IVL may have a shape that surrounds all the first and second touch driving lines TL1 and TL2 and the touch sensing line RL along the outermost edge of the touch peripheral area TPA. Alternatively, the inspection signal transmission line IVL may cross the touch sensing area TSA and the touch peripheral area TPA. For example, to stop the driving electrode TE and the sensing electrodes RE from electrically contacting each other, the inspection signal transmission line IVL in the touch sensing area TSA and the touch peripheral area TPA may cross the touch sensing area TSA in the first direction (X-axis direction) or the second direction (Y-axis direction). One end of the inspection signal transmission line IVL may be electrically connected to a first touch pad TP1 disposed in the pad unit PD, and the other end of the inspection signal transmission line IVL may be electrically connected to a second touch pad TP2. Alternatively, the one end and the other end of the inspection signal transmission line IVL may be respectively connected to the first touch pads TP1 or the second touch pads TP2.

When the display circuit board 300 is connected to one side of the flexible film as shown in FIGS. 1 to 3, the display pad area DPA and the first and second touch pad areas TPA1 and TPA2 of the pad unit PD may be associated with pads of the display panel 100 connected to the circuit board 300. Accordingly, the pads of the display panel 100 may be in contact with the display pads DP, the first touch pads TP1 and the second touch pads TP2. The display pads DP, the first touch pads TP1 and the second touch pads TP2 may be electrically connected to the pads of the circuit board 300 using a low-resistance, high-reliability material such as an anisotropic conductive layer and an SAP. Therefore, the display pads DP, the first touch pads TP1 and the second touch pads TP2 may be electrically connected to the touch driving circuit 400 disposed on the circuit board 300.

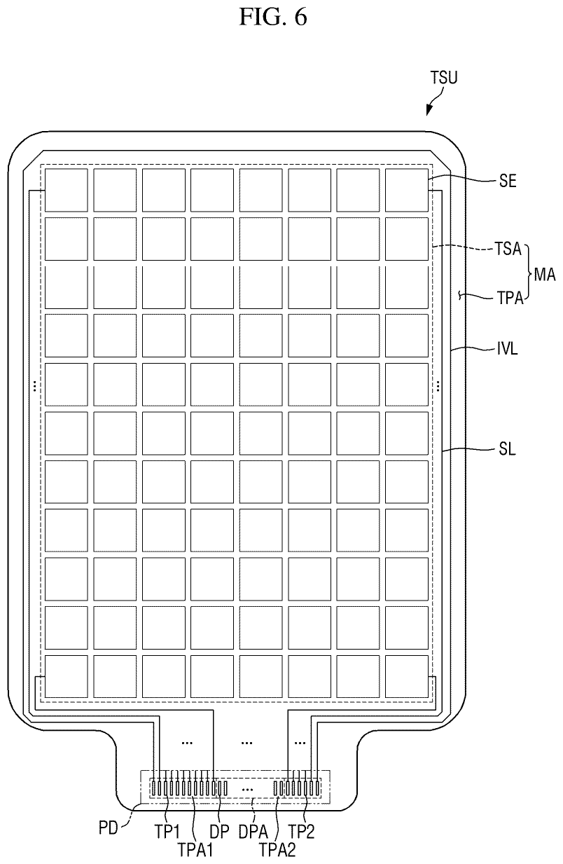

FIG. 6 schematically shows a layout of a second embodiment of the touch sensing unit shown in FIG. 3.

Referring to FIG. 6, a plurality of touch electrodes SE may be formed and arranged in a matrix structure (in plan view) in the touch sensing area TSA of the touch sensing unit TSU. The touch electrodes SE may be connected in a one-to-one manner to the touch lines SL, which extend along the touch sensing area TSA in the touch peripheral area TPA.

Although a structure in which each of the touch electrodes SE are formed in a planar rectangular shape is exemplified in FIG. 6, the present disclosure is not limited thereto. For example, other than a rectangular shape, the touch electrodes SE may be formed in a planar polygonal shape other than a rhombus shape, a square shape, a quadrangular shape, or a planar circular shape, or a planar elliptical shape.

The touch electrodes SE may be connected to the touch lines SL extending into any side of the touch sensing area TSA and may receive a touch driving signal through the touch lines SL.

Each of the touch lines SL may partially pass through the touch peripheral area TPA and connect to the pad unit PD in the sub-area SBA of the display panel 100. For example, each of the touch lines SL may pass through the left, right, or lower side of the touch sensing area TSA and connect to the pad unit PD formed in the sub-area SBA. The touch lines SL may particularly be connected one-to-one to the first and second touch pads TP1 and TP2 disposed in the pad unit PD.

Referring to FIG. 6, at least one of the inspection signal transmission line IVL may be disposed in the touch peripheral area TPA along the periphery of the touch sensing area TSA. The inspection signal transmission line IVL may be formed through the same process on the same process layer with the same metal material as at least one touch electrode SE or at least one touch line SL. The inspection signal transmission line IVL may be formed in the touch peripheral area TPA. For example, the inspection signal transmission line IVL may be disposed along the outermost edge of the touch peripheral area TPA in a shape surrounding all the touch electrodes SE and the touch lines SL.

One end of the inspection signal transmission line IVL may be electrically connected to the first touch pad TP1 disposed on the pad unit PD, and the other end thereof may be electrically connected to the second touch pad TP2.

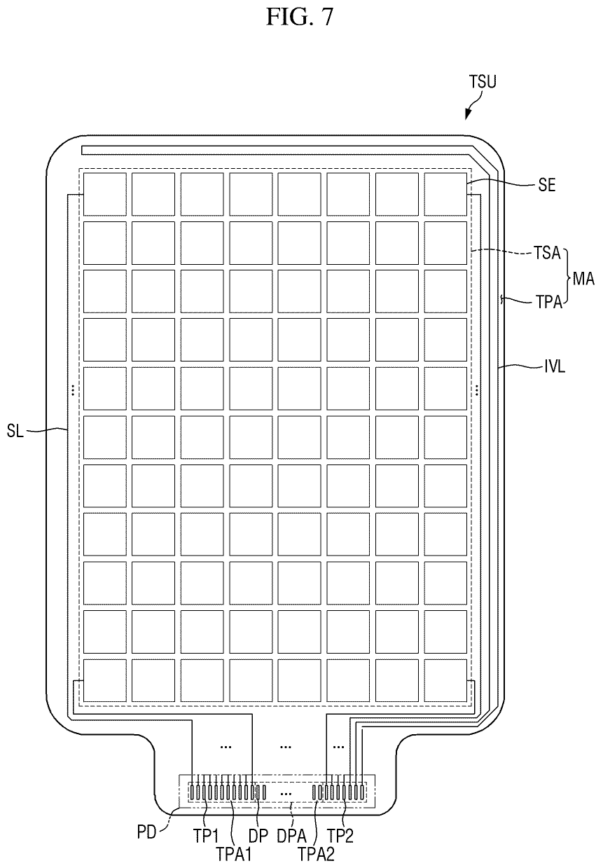

FIG. 7 schematically shows a layout of a third embodiment of the touch sensing unit shown in FIG. 3. The touch sensing unit TSU of FIG. 7 may have touch electrodes SE and touch lines SL that are the same as those described above. Referring to FIG. 7, the inspection signal transmission line IVL may be disposed outside of the touch sensing area TSA, the touch electrodes SE, and the touch lines SL and may extend in the first direction (e.g., X-axis direction) along the lower side and the upper side of the touch sensing area TSA and extend in the second direction (e.g., Y-axis direction) along one (left or right) side of the touch sensing area TSA. The inspection signal transmission line IVL along the upper side may loop back and return along the upper side, the one side, and the lower side of the touch sensing area TSA, the touch electrodes SE, and the touch lines SL. The ends of the inspection signal transmission line IVL may be one-to-one connected to the first touch pads TP1 or may be one-to-one connected to the second touch pads TP2.

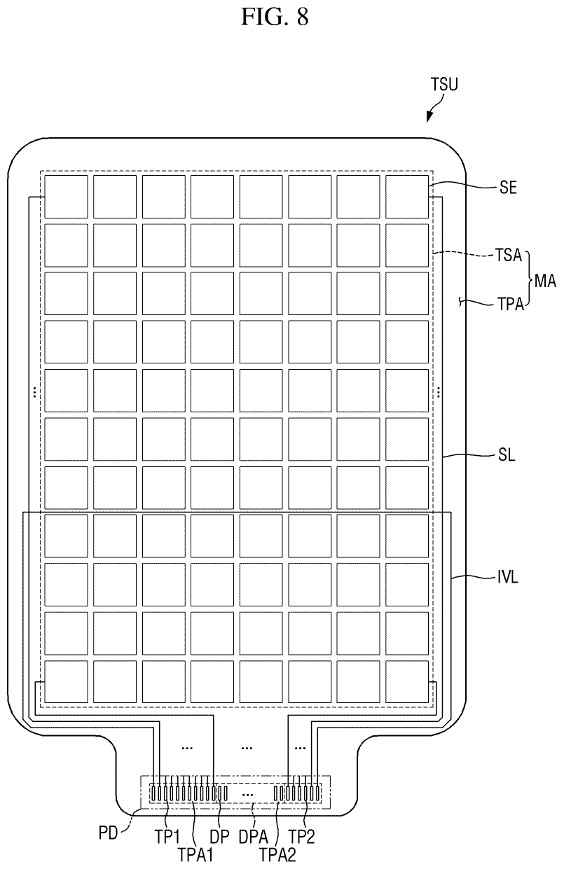

FIG. 8 schematically shows a layout of a fourth embodiment of the touch sensing unit shown in FIG. 3. The touch sensing unit TSU of FIG. 8 may have touch electrodes SE and touch lines SL that are the same as those described above. Referring to FIG. 8, the inspection signal transmission line IVL may pass through the touch sensing area TSA at least once. The inspection signal transmission line IVL may be disposed in the touch sensing area TSA and the touch peripheral area TPA, passing the touch sensing area TSA in the first direction (e.g., X-axis direction) or the second direction (e.g., Y-axis direction) at least once. In order to not be electrically connected to the touch electrodes SE and the touch lines SL, the inspection signal transmission line IVL may be formed through the same process on the same process layer with the same metal material as at least one touch electrode SE but in a gap between the touch electrodes SE. In addition, or alternatively, the inspection signal transmission line IVL may be formed on a process layer different from at least one touch line SL. The touch electrodes SE may be electrically connected through contact holes to respective touch lines SL. The inspection signal transmission line IVL and the touch lines SL may be one-to-one connected to the first or second touch pad TP1 or TP2 disposed in the pad unit PD through contact holes, connection lines, or the like. One end of the inspection signal transmission line IVL may be electrically connected to the first touch pad TP1 disposed in the pad unit PD, and the other end thereof may be electrically connected to the second touch pad TP2 in the pad unit PD.

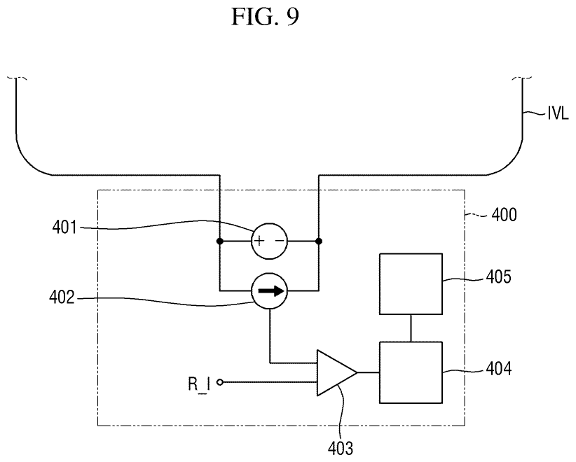

FIG. 9 is a block diagram schematically illustrating a first embodiment of the touch driving circuit 400 of FIGS. 1 to 3. The touch driving circuit 400 may be electrically connected to the inspection signal transmission line IVL and the touch lines SL of the touch sensing unit TSU through the first and second touch pads TP1 and TP2.

FIG. 9 shows the touch driving circuit 400 connected to the signal transmission line IVL to illustrate detection of manufacturing process deviations. In order to detect deviations in the manufacturing process of the display panel 100 or the touch sensing unit TSU or deviations according to changes in the usage environment and usage time, the touch driving circuit 400 may supply an electrical inspection signal to one end of the inspection signal transmission line IVL, e.g., through the first or second touch pad TP1 or TP2. Here, the touch driving circuit 400 may supply an inspection signal to one end of the inspection signal transmission line IVL in real time or repeatedly according to a preset period. In addition, the touch driving circuit 400 may detect change in a current amount or voltage magnitude in real time or repetitively through at least one end (among the one end and the other end) of the inspection signal transmission line IVL.

The touch driving circuit 400 may also change the voltage magnitude or current amount of the touch driving signals supplied to the touch lines SL and the touch electrodes SE based on measured changes in the voltage magnitude or current amount of the inspection signal. To this end, the touch driving circuit 400 may include an inspection signal supply unit 401, a current amount detection unit 402, a comparison circuit unit 403, a compensation value extraction unit 404, and a signal control unit 405.

The inspection signal supply unit 401 may supply the inspection signal with a preset voltage level to the inspection signal transmission line IVL of the touch sensing unit TSU in real time or repeatedly at the preset period. For one example, the inspection signal supply unit 401 may include a transformer circuit that generates an inspection signal with a current of 60 mA to 250 mA and a voltage of 5 V to 12 V. The inspection signal supply unit 401 may supply an inspection signal with a current of 60 mA to 250 mA and a voltage of 5 to 12 V to at least one end of the inspection signal transmission line IVL.

The current amount detection unit 402 is electrically connected to at least one end of the inspection signal transmission line IVL and detects the amount of current flowing in inspection signal transmission line IVL. The current amount detection unit 402 may include at least one current transformer, such as a shunt resistor or a current conversion circuit.

The comparison circuit unit 403 compares the current amount detected through the current amount detection unit 402 with a preset reference current amount R_I and outputs a comparison signal corresponding to the current amount difference value. The comparison circuit unit 403 may include at least one digital logic circuit unit such as an operational amplifier or comparator with an analog-to-digital converter. Accordingly, the comparison circuit unit 403 may supply a digital comparison signal corresponding to the current amount difference between the current amount detected through the current amount detection unit 402 and the reference current amount to the compensation value extraction unit 404.

The compensation value extraction unit 404 extracts a compensation value, which may be preset to be inversely proportional to the current amount difference value included in the comparison signal output from the comparison circuit unit 403, and the compensation value extraction unit 404 supplies the extracted compensation value to the signal control unit 405. Compensation values that are inversely proportional to the difference value between the current amount detected through the current amount detection unit 402 and the reference current amount R_I may be stored in advance in a memory, a look-up table, or the like.

The signal control unit 405 select the voltage magnitude or current amount of the touch driving signal according to the compensation value output from the compensation value extraction unit 404 and may supply the selected voltage magnitude or current amount to a plurality of touch electrodes SE or driving electrodes TE. The signal control unit 405 may include at least one transformer circuit, a power supply circuit, and a variable resistor.

TABLE 1

| Line width or | | | TE Driving |
|---|---|---|---|
| line thickness | Line resistance | TE Setting AVDD | AVDD |
| Min | Max | 3.6 V | 3.6 V |
| Typical | Typical | 3.3 V | 3.3 V |
| Max | Min | 3.0 V | 3.0 V |

Table 1 indicates how the resistances of the driving electrodes TE, touch lines SL, and inspection signal transmission lines IVL in the touch sensing unit TSU increase as the line width or line thickness becomes narrower. As the line width or line thickness of the touch lines SL and the inspection signal transmission lines IVL becomes narrower and resistance increases, the amount of current of the inspection signal transmission lines IVL detected through the current amount detection unit 402 decreases and less current is detected.

The comparison circuit unit 403 compares the present reference current amount R_I to the amount of current that the current amount detection unit 402 detected, and based on the comparison, the comparison circuit unit 403 outputs a comparison signal corresponding to the difference between the currents, The compensation value extraction unit 404 extracts a compensation value that is inversely proportional to the difference value indicated by the comparison signal and supplies the compensation value to the signal control unit 405.

As illustrated in Table 1, the signal control unit 405 may increase or set the voltage magnitude and current amount of the touch driving signal according to the compensation value (TE Setting AVDD) output from the compensation value extraction unit 404. In addition, the signal control unit 405 may supply the increased voltage magnitude (TE Driving AVDD) and current amount of the touch driving signal to the touch lines SL and a plurality of touch electrodes SE or driving electrodes TE.

Conversely, as the line width or line thickness of the touch lines SL and the inspection signal transmission lines IVL becomes larger or wider and the resistance decreases, the current amount of the inspection signal transmission lines IVL detected through the current amount detection unit 402 increases and is detected more frequently. The signal control unit 405 lowers and sets the voltage magnitude and current amount of the touch driving signal according to the compensation value (TE Setting AVDD) output from the compensation value extraction unit 404. In addition, signal control unit 405 supplies the lowered voltage magnitude (TE Driving AVDD) and current amount of the touch driving signal through the touch lines SL to a plurality of touch electrodes SE or driving electrodes TE.

When the line width or line thickness of the touch lines SL and the inspection signal transmission lines IVL are formed according to normal standards, the current amount detected through the current amount detection unit 402 may be within the same range as the preset reference current amount R_I. The signal control unit 405 sets the voltage magnitude (TE Setting AVDD) and current amount of the touch driving signal to the reference magnitude and reference current amount according to the compensation value in the normal range output from the compensation value extraction unit 404. Then, the voltage magnitude (TE Driving AVDD) and current amount of the touch driving signal are supplied through the touch lines SL to a plurality of touch electrodes SE or driving electrodes TE according to the reference magnitude and reference current amount.

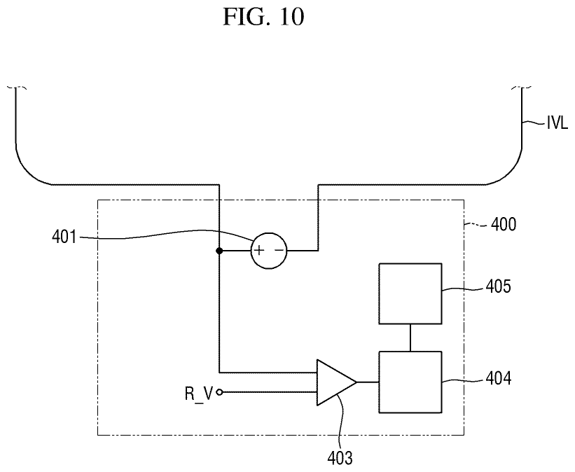

FIG. 10 is a block diagram schematically illustrating a second embodiment of the touch driving circuit 400 shown in FIGS. 1 to 3. Referring to FIG. 10, the touch driving circuit 400 includes an inspection signal supply unit 401, a comparison circuit unit 403, a compensation value extraction unit 404, and a signal control unit 405.

The inspection signal supply unit 401 supplies an inspection signal with a preset voltage level to the inspection signal transmission line IVL of the touch sensing unit TSU in real time or according to a preset period. The inspection signal supply unit 401 may supply an inspection signal with a current of 60 mA to 250 mA and a voltage of 5 to 12 V to at least one end of the inspection signal transmission line IVL.

The comparison circuit unit 403 is electrically connected to one end of the inspection signal transmission line IVL, for example, the other end of the inspection signal transmission line IVL, and compares the voltage magnitude of the inspection signal transmission line IVL to a preset reference voltage source R_V. Then, the comparison circuit unit 403 outputs a comparison signal corresponding to the voltage magnitude difference to the compensation value extraction unit 404. To this end, the comparison circuit unit 403 may include at least one digital logic circuit unit such as an operational amplifier or comparator with an analog-to-digital converter.

The compensation value extraction unit 404 extracts, e.g., using a lookup table, a compensation value that is inversely proportional to the difference in voltage magnitude indicated by the comparison signal output from the comparison circuit unit 403. The compensation value extraction unit 404 supplies the extracted compensation value to the signal control unit 405.

The signal control unit 405 may supply to the touch lines SL and a plurality of touch electrodes SE or driving electrodes TE the voltage magnitude and current amount of the touch driving signal that corresponds to the compensation value output from the compensation value extraction unit 404.

The signal control unit 405 may increase or lower and set the voltage magnitude and current amount of the touch driving signal according to the compensation value (TE Setting AVDD) output from the compensation value extraction unit 404. Alternatively, the signal control unit 405 may set the voltage magnitude and current amount of the touch driving signal to the reference magnitude and reference current amount according to the compensation value (TE Setting AVDD). in the normal range output from the compensation value extraction unit 404. In addition, the signal control unit 405 may raise or lower the voltage magnitude (TE Driving AVDD) and current amount of the touch driving signal and supply them to a plurality of touch electrodes SE or driving electrodes TE. The signal control unit 405 may supply the voltage magnitude and current amount of the touch driving signal to a plurality of touch electrodes SE or driving electrodes TE according to the reference magnitude and reference current amount (TE Driving AVDD).

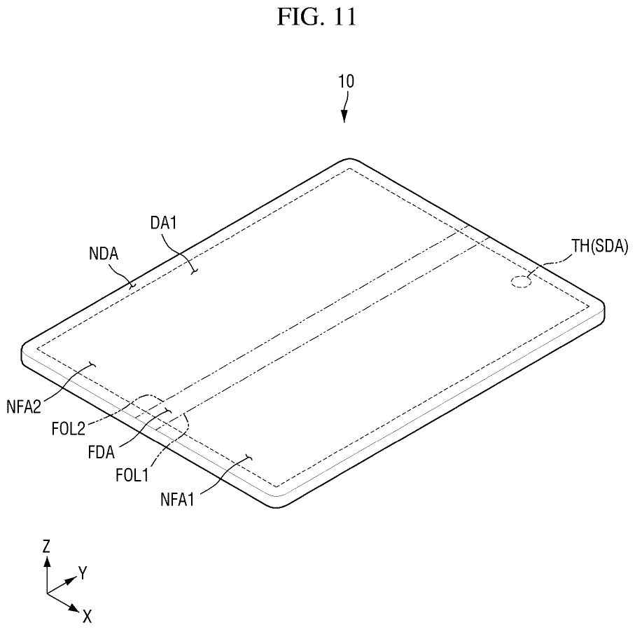

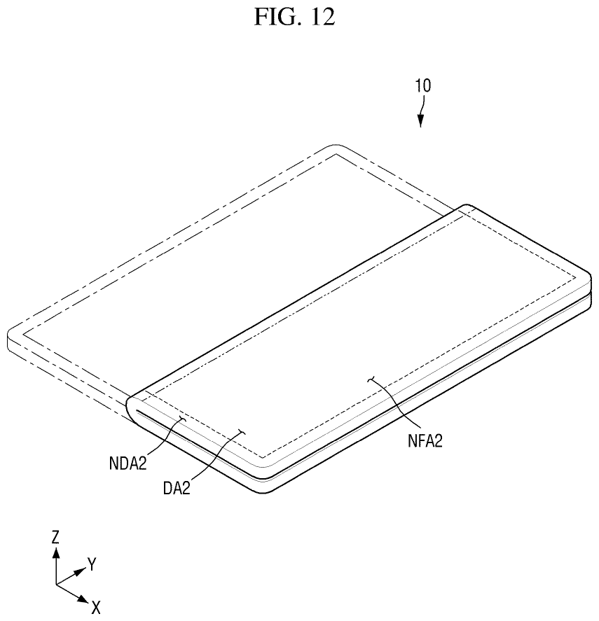

FIGS. 11 and 12 are perspective views illustrating a display device according to another embodiment of the present disclosure.

FIGS. 11 and 12 illustrate the display device 10 as a foldable display device that folds about an axis extending in the second direction (Y-axis direction). The display device 10 may be in a folded state (FIG. 12) or an unfolded state (FIG. 11). The display device 10 may be folded in an in-folding manner in which the front surface is disposed on the inside the display device 10 when the display device is in the folded state. When the display device 10 is bent or folded in the in-folding manner, portions of the front surface of the display device 10 may face each other. Alternatively, the display device 10 may be folded in an out-folding manner in which the front surface is disposed on the outside of the display device 10 when the display device 10 is folded. When the display device 10 is bent or folded in the out-folding manner, the rear surfaces of the display device 10 may face each other.

The display device 10 of FIGS. 11 and 12 may have a first non-folding area NFA1 on one side, for example, the right side of a folding area FDA. A second non-folding area NFA2 may be on the other side, for example, the left side of the folding area FDA. The touch sensing unit TSU according to an embodiment of the present disclosure may be disposed on each of the first non-folding area NFA1 and the second non-folding area NFA2.

A first folding line FOL1 and a second folding line FOL2 extend in the second direction (Y-axis direction), and the display device 10 may be folded about an axis parallel to the first and second folding lines FOL1 and FOL2. Accordingly, folding the display device 10 may reduce the length of the display device 10 in the first direction (X-axis direction) approximately by half, so that a user can conveniently carry the display device 10.

The first folding line FOL1 and the second folding line FOL2 are not limited to being lines that extend in the second direction (Y-axis direction). For example, the first folding line FOL1 and the second folding line FOL2 may extend in the first direction (X-axis direction), and the display device 10 may be folded in the second direction (Y-axis direction). In this case, folding may reduce the length of the display device 10 in the second direction (Y-axis direction) approximately by half. Alternatively, the first folding line FOL1 and the second folding line FOL2 may extend in a diagonal direction of the display device 10 between the first direction (X-axis direction) and the second direction (Y-axis direction). In this case, the display device 10 having a rectangular shape may be folded into a triangular shape.

When the first folding line FOL1 and the second folding line FOL2 extend in the second direction (Y-axis direction), the length of the folding area FDA in the first direction (X-axis direction) may be shorter than the length thereof in the second direction (Y-axis direction). Further, the length of the first non-folding area NFA1 in the first direction (X-axis direction) may be longer than the length of the folding area FDA in the first direction (X-axis direction). The length of the second non-folding area NFA2 in the first direction (X-axis direction) may be longer than the length of the folding area FDA in the first direction (X-axis direction).

The first display area DA1 may be on the front surface of the display device 10. The first display area DA1 may overlap the folding area FDA, the first non-folding area NFA1, and the second non-folding area NFA2. Therefore, when the display device 10 is unfolded, an image may be displayed toward the front side in the folding area FDA, the first non-folding area NFA1, and the second non-folding area NFA2 of the display device 10.

The second display area DA2 may be on the rear surface of the display device 10. The second display area DA2 may overlap the second non-folding area NFA2. Therefore, when the display device 10 is folded, an image may be displayed toward the third direction (Z-axis direction) in the second non-folding area NFA2 of the display device 10 as shown in FIG. 12.

FIGS. 11 and 12 further illustrate that a through hole TH for a camera may be disposed in the first non-folding area NFA1, but the present disclosure is not limited thereto. The through hole TH or the camera may be disposed in the second non-folding area NFA2 or the folding area FDA.

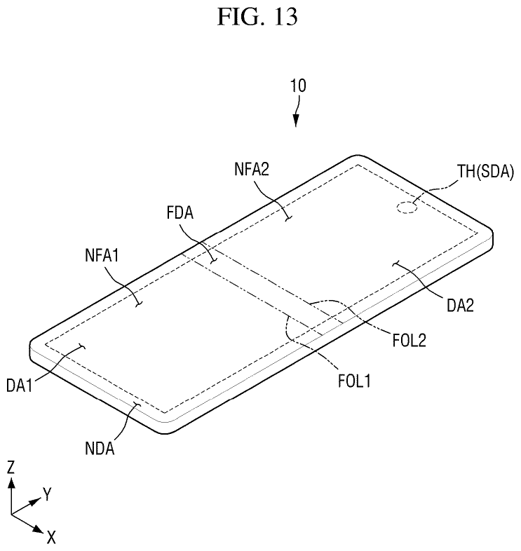

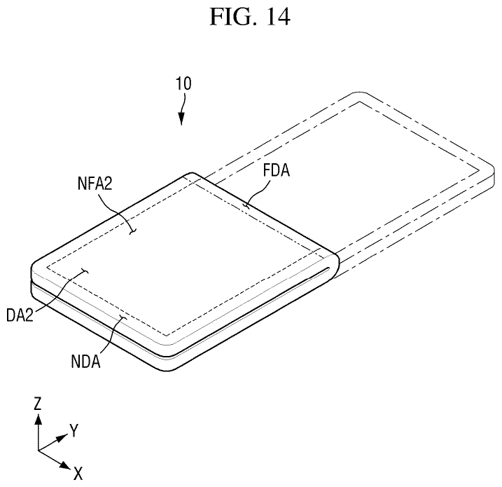

FIGS. 13 and 14 are perspective views illustrating a display device according to still another embodiment of the present disclosure.

FIGS. 13 and 14 illustrate the display device 10 as a foldable display device that may be folded about an axis extending in the first direction (X-axis direction). The display device 10 has a folded state shown in FIG. 14 and an unfolded state shown in FIG. 13. The display device 10 may be folded in an in-folding manner in which the front surface is inside the folded display device 10. When the display device 10 is bent or folded in the in-folding manner, the front surfaces of the display device 10 may face each other. Alternatively, the display device 10 may be folded in an out-folding manner in which the front surface is disposed on the outside of the display device 10. When the display device 10 is bent or folded in the out-folding manner, portions of the rear surface of the display device 10 may face each other.

The display device 10 may include a folding area FDA, the first non-folding area NFA1, and the second non-folding area NFA2. The folding area FDA may be an area in which the display device 10 is folded, and the first and second non-folding areas NFA1 and NFA2 may be areas in which the display device 10 is not folded. The first non-folding area NFA1 may be disposed on one side (e.g., a lower side) of the folding area FDA. The second non-folding area NFA2 may be disposed on the other side (e.g., an upper side) of the folding area FDA.

The touch sensing unit TSU according to an embodiment of the present disclosure may be disposed on each of the first non-folding area NFA1 and the second non-folding area NFA2.

When the display device 10 is folded, the folding area FDA may be a curved area with a predetermined curvature between a first folding line FOL1 and a second folding line FOL2. Thus, the first folding line FOL1 may be the boundary between the folding area FDA and the first non-folding area NFA1, and the second folding line FOL2 may be the boundary between the folding area FDA and the second non-folding area NFA2. The first folding line FOL1 and the second folding line FOL2 may extend in the first direction (X-axis direction) as shown in FIGS. 13 and 14. In this case, the display device 10 may be folded in the second direction (Y-axis direction). Accordingly, the length of the display device 10 in the second direction (Y-axis direction) may be reduced by approximately half, so that a user can conveniently carry the display device 10.

The first folding line FOL1 and the second folding line FOL2 are not limited to being lines that extend in the first direction (X-axis direction). For example, the first folding line FOL1 and the second folding line FOL2 may extend in the second direction (Y-axis direction), and the display device 10 may be folded in the first direction (X-axis direction). In this case, the length of the display device 10 in the first direction (X-axis direction) may be reduced to approximately half. Alternatively, the first folding line FOL1 and the second folding line FOL2 may extend in a diagonal direction of the display device 10 between the first direction (X-axis direction) and the second direction (Y-axis direction). In this case, the display device 10 may be folded from a rectangular shape into a triangular shape.

When the first folding line FOL1 and the second folding line FOL2 extend in the first direction (X-axis direction) as shown in FIGS. 13 and 14, the length of the folding area FDA in the second direction (Y-axis direction) may be shorter than the length of the folding area FDA in the first direction (X-axis direction). Further, the length of the first non-folding area NFA1 in the second direction (Y-axis direction) may be longer than the length of the folding area FDA in the second direction (Y-axis direction). The length of the second non-folding area NFA2 in the second direction (Y-axis direction) may be longer than the length of the folding area FDA in the second direction (Y-axis direction).

The first display area DA1 may be disposed on the front surface of the display device 10. The first display area DA1 may overlap the folding area FDA, the first non-folding area NFA1, and the second non-folding area NFA2. Therefore, when the display device 10 is unfolded, an image may be displayed toward the front side thereof in the folding area FDA, the first non-folding area NFA1, and the second non-folding area NFA2 of the display device 10.

The second display area DA2 may be disposed on the rear surface of the display device 10. The second display area DA2 may overlap the second non-folding area NFA2. Therefore, when the display device 10 is folded, an image may be displayed toward the front side thereof in the second non-folding area NFA2 of the display device 10.

FIGS. 13 and 14 further illustrate a through hole TH in which the camera or the like may be disposed in the second non-folding area NFA2, but the present disclosure is not limited thereto. The through hole TH may be disposed in the first non-folding area NFA1 or the folding area FDA.

In concluding the detailed description, those skilled in the art will appreciate that many variations and modifications can be made to the illustrated embodiments without substantially departing from the principles of the present disclosure. Therefore, the disclosed embodiments are used in a generic and descriptive sense only and not for purposes of limitation.

What is claimed is:

1. A touch detection module comprising:
a touch sensing unit including touch electrodes and an inspection signal transmission line, the touch electrodes being in a touch sensing area of the touch sensing unit and being connected to touch lines that extend through a touch peripheral area of the touch sensing unit; and
a touch driving circuit supplying an inspection signal to the inspection signal transmission line and changing a voltage magnitude or a current amount of touch driving signals supplied to the touch electrodes, the changing being according to a voltage magnitude or a current amount of the inspection signal,
wherein the touch driving circuit supplies the touch driving signals in which the voltage magnitude or the current amount has changed to the touch electrodes and detects touch sensing signals from the touch electrodes to detect coordinates of a touch location.

2. The touch detection module of claim 1,
wherein the inspection signal transmission line is disposed in at least one of the touch sensing area and the touch peripheral area, and
wherein the inspection signal transmission line is formed on the same process layer with the same metal material as at least one touch electrode among the touch electrodes or at least one touch line among the touch lines.

3. The touch detection module of claim 2,
wherein the inspection signal transmission line is disposed in a shape surrounding the touch lines and the touch sensing area along an outermost portion of the touch peripheral area.

4. The touch detection module of claim 3,
wherein the touch sensing unit further includes a pad unit in the peripheral area, and
wherein one end of the inspection signal transmission line is electrically connected to a first touch pad disposed on one side of the pad unit, and the other end of the inspection signal transmission line is electrically connected to a second touch pad disposed on the other side of the pad unit.

5. The touch detection module of claim 2,
wherein the inspection signal transmission line is disposed in the touch sensing area and the touch peripheral area crossing the touch sensing area at least once in plan view without being electrically connected to the touch electrodes or the touch lines.

6. The touch detection module of claim 5,
wherein the inspection signal transmission line is formed on the same process layer with the same metal material as at least one touch electrode and is formed on a different process layer from the touch lines.

7. The touch detection module of claim 2,
wherein the inspection signal transmission line extends along a second direction below a lower edge of the touch sensing area, in a first direction outside a side of the of the touch sensing area, and along the second direction above an upper edge of the touch sensing area.

8. The touch detection module of claim 2,
wherein the inspection signal transmission line is disposed in the touch peripheral area outside an upper edge, one side, and a lower edge of the touch sensing area, the touch electrodes, and the touch lines.

9. The touch detection module of claim 8,
wherein one end of the inspection signal transmission line is electrically connected to a first touch pad disposed on a first side of a pad unit of the touch sensing unit, and the other end of the inspection signal transmission line is electrically connected to a second touch pad disposed on the first side of the pad unit.

10. The touch detection module of claim 2,
wherein the touch driving circuit supplies the inspection signal to a first end of the inspection signal transmission line in real time or for each preset period, detects change of a current amount or voltage magnitude through at least one of the first end and a second end of the inspection signal transmission line, and changes the current amount or voltage magnitude of the touch driving signals to correspond to the change of the current amount or voltage magnitude of the inspection signal.

11. The touch detection module of claim 10,
wherein the touch driving circuit comprises:
an inspection signal supply unit supplying the inspection signal of a preset voltage magnitude to the inspection signal transmission line;
a current amount detection unit detecting a current amount flowing in the inspection signal transmission line;
a comparison circuit unit that compares the current amount detected through the current amount detection unit with a preset reference current amount and that outputs a comparison signal corresponding to a current amount difference;
a compensation value extraction unit extracting and outputting a compensation value that is inversely proportional to the current amount difference; and
a signal control unit changing the current amount or voltage magnitude of the touch driving signals to correspond to the compensation value outputted from the compensation value extraction unit.

12. The touch detection module of claim 10,
wherein the touch driving circuit comprises:
an inspection signal supply unit supplying the inspection signal of a preset voltage magnitude to the inspection signal transmission line;
a comparison circuit unit electrically connected to at least one end of the inspection signal transmission line and configured to compare the voltage magnitude of the inspection signal transmission line with a reference voltage and to output a comparison signal corresponding to a voltage magnitude difference;
a compensation value extraction unit extracting and outputting a compensation value that is inversely proportional to the voltage magnitude difference; and
a signal control unit changing the current amount or voltage magnitude of the touch driving signals to correspond to the compensation value outputted from the compensation value extraction unit.

13. A display device comprising:
a display panel including a display area in which a plurality of subpixels are arranged; and
a touch detection module on the display panel and configured to sense touch of a user,
wherein the touch detection module comprises:
a touch sensing unit including touch electrodes and an inspection signal transmission line, the touch electrodes being in a touch sensing area of the touch sensing unit and being connected to touch lines that extend through a touch peripheral area of the touch sensing unit; and
a touch driving circuit supplying an inspection signal to the inspection signal transmission line and a changing current amount or voltage magnitude of touch driving signals supplied to the touch electrodes, the changing being according to a change in a current amount or a voltage magnitude of the inspection signal,
wherein the touch driving circuit supplies the touch driving signals in which the voltage magnitude or the current amount has changed to the touch electrodes and detects touch sensing signals from the touch electrodes to detect coordinates of a touch location.

14. The display device of claim 13,
wherein the inspection signal transmission line is disposed in at least one of the touch sensing area and the touch peripheral area, and
wherein the inspection signal transmission line is formed on the same process layer with the same metal material as at least one touch electrode among the touch electrodes or at least one touch line among the touch lines.

15. The display device of claim 14,
wherein the inspection signal transmission line is disposed in a shape surrounding the entire touch lines and the touch sensing area along an outermost portion of the touch peripheral area.

16. The display device of claim 14,
wherein the inspection signal transmission line is disposed in the touch sensing area and the touch peripheral area crossing the touch sensing area at least once in plan view without being electrically connected to the touch electrodes or the touch lines.

17. The display device of claim 14,
wherein the inspection signal transmission line extends along a second direction below a lower edge of the touch sensing area, in a first direction outside a side of the touch sensing area, and along the second direction above an upper edge of the touch sensing area.

18. The display device of claim 14,
wherein the touch driving circuit supplies the inspection signal to a first end of the inspection signal transmission line in real time or for each preset period, detects change of a current amount or voltage magnitude through at least one of the first end and a second end of the inspection signal transmission line, and change the current amount or voltage magnitude of the touch driving signals to correspond to the change of the current amount of voltage magnitude of the inspection signal.

19. The display device of claim 18,
wherein the touch driving circuit comprises:
an inspection signal supply unit supplying the inspection signal of a preset voltage magnitude to the inspection signal transmission line;
a current amount detection unit detecting a current amount flowing in the inspection signal transmission line;
a comparison circuit unit that compares the current amount detected through the current amount detection unit with a preset reference current amount and that outputs a comparison signal corresponding to a current amount difference;
a compensation value extraction unit extracting and outputting a compensation value that is inversely proportional to the current amount difference; and
a signal control unit changing the current amount or voltage magnitude of the touch driving signal to correspond to the compensation value outputted from the compensation value extraction unit.

20. The display device of claim 18,
wherein the touch driving circuit comprises:
an inspection signal supply unit supplying the inspection signal of a preset voltage magnitude to the inspection signal transmission line;
a comparison circuit unit electrically connected to at least one end of the inspection signal transmission line, the comparison unit being configured to compare the voltage magnitude of the inspection signal transmission line with a reference voltage and to output a comparison signal corresponding to a voltage magnitude difference;
a compensation value extraction unit extracting and outputting a compensation value that is inversely proportional to the voltage magnitude difference of the comparison signal; and
a signal control unit changing the current amount or voltage magnitude of the touch driving signals to correspond to the compensation value outputted from the compensation value extraction unit.
